(19) United States
(12) Patent Application Publication
(10) Pub. No.: US 2020/0160603 A1
(43) Pub. Date: May 21, 2020

(54) DYNAMIC AUGMENTED REALITY VISION SYSTEMS

(71) Applicant: PETER ELLENBY, SAN FRANCISCO, CA (US)

(72) Inventor: PETER ELLENBY, SAN FRANCISCO, CA (US)

(21) Appl. No.: 16/515,983

(22) Filed: Jul. 18, 2019

Related U.S. Application Data
(63) Continuation of application No. 13/783,352, filed on Mar. 3, 2013, now abandoned.

(51) Int. Cl. G06T 19/00

(52) U.S. Cl. CPC G06T 19/006; G06T 2210/36

(57) ABSTRACT

Imaging systems which include an augmented reality feature are provided with automated means to throttle or excite the augmented reality generator. Compound images are presented whereby an optically captured image is overlaid with a computer-generated image portion to from the complete augmented image for presentation to a user. Upon the particular conditions of the imager, imaged scene and the Imaging environment, these imaging systems include automated responses. Computer-generated images which are overlaid optically captured images are either bolstered all in the detail and content where an increase in information is needed, or they are tempered when a decrease in information is preferred as determined by prescribed conditions and values.

### PRIORITY CLAIMS

This application claims the benefit and is a continuation of U.S. patent application Ser. No. 13/783,352, filed on Mar. 3, 2013, the contents of which are incorporated herein by reference.

### BACKGROUND OF THE INVENTION

### Field of the Invention

The following invention disclosure is generally concerned with electronic vision systems and specifically concerned with highly dynamic and adaptive augmented reality vision systems.

### Related Systems

Vision systems today include video cameras having LED displays, electronic documents, infrared viewers among others. Various types of these electronic vision systems have evolved to include computer-based enhancements. Indeed, it is now becoming possible to use a computer to reliably augment optically captured images with computer-generated graphics to form compound images. Systems known as Augmented Reality capture images of scenes being addressed with traditional lenses and sensors to form an image to which computer-generated graphics may be added.

In some versions, simple real-time image processing yields a device with means for superimposing graphics generated by a computer with optically captured images. For example, edge detection processing may be used to determine precise parts of an image scene which might be manipulated with the addition of computer generated graphics aligned therewith.

In one simple example of basic augmented reality now commonly observed, enhancements which relate to improvements in sports broadcast are found on the family television on winter Sunday afternoons. In an image of a sports scene including a football grid iron, there is sometimes particular significance of an imaginary line which relates to the rules of play; i.e., the first down line indicator. Since it is very difficult to envision this imaginary line, an augmented reality image makes understanding the game much easier. A computer determines the precise location and perspective of this imaginary line. The computer generates a high contrast enhancement to visually show same. In football, a “first down” line which can easily be seen during play as represented by an optically captured video makes it easy for the viewer to readily discern the outcome of a first down attempt thus improving the football television experience.

While augmented reality electronic vision systems are just beginning to be found in common use, one should expect more each day as these technologies are presently in rapid advance. Computers may now be arranged to enhance optically captured images in real time by adding computer-generated graphics thereto.

Some important versions of such imaging systems include those in which the computer-generated portion of the compound image includes a level of detail which depends upon the size of a particular point of interest Either by way of a manual or user selection step or by way of inference, the system declares a point of interest of object of high importance. The size of the object with respect to the size of the image field dictates to computer generation schemes the level of detail. When a point of interest is quite small in the image scene, the level of computer augmentation is preferable much less. Thus, dynamically augmented reality systems are those in which the level of augmentation responds to attributes of the scene among other important factors. It would be most useful if the level of augmentation were responsive to other image scene attributes. For example, instant weather conditions. Further, it would be quite useful if the level of augmentation were responsive to preferential user selections with respect to certain objects of interest. Still further, it would be most useful if augmented reality systems were responsive to a manual input in which a user specifies a level of detail. These and other dynamic augmented reality features and systems are taught and first presented in the following graphs.

While systems and inventions of the art are designed to achieve particular goals and objectives, some of those being no less than remarkable, these inventions of the art have nevertheless include limitations which prevent uses in new ways now possible. inventions of the art are not used and cannot. be used to realize advantages and objectives of the teachings presented herefollowing.

### SUMMARY OF THE INVENTION

Comes now, Peter and Thomas Ellenby with inventions of dynamic vision systems including devices and methods of adjusting computer generated imagery in response to detected states of an optical signal, the imaged scene, the environments about the scene, and manual user inputs. It is a primary function of this invention to provide highly dynamic vision systems for presenting augmented reality type images,

Imaging systems ‘aware’ of the nature of imaging scenarios in which they are used, and further aware of some user preferences; adjust themselves to provide augmented reality images most suitable for the particular imaging circumstance to yield most highly relevant compound images. An augmented reality generator or computer graphics generation facility is responsive to conditions relating to scenes being addressed as well as certain user specified parameters. Specifically; an augmented reality imager provides computer-generated graphics (usually a level of detail) appropriate for environmental conditions such as fog or inclement weather, nightfall, et cetera. Further, some important versions of these systems are responsive to user selections of particular objects of interest—or ‘points of interest’ (POI). In other versions, augmented reality is provided whereby a level of detail is adjusted for the relative size of a particular object of interest

While augmented reality remains a marvelous technology being slowly integrated with various types of conventional electronic imagers, heretofore publically known augmented reality systems having a computer graphics generator are largely or wholly static, The present disclosure describes highly sophisticated computer graphics generators which are part of augmented reality imagers whereby the computer graphics facility is dynamic and responsive to particulars of scenes being imaged,

Either by measurement and sensors, among other means, imaging systems presented herein determine atmospheric, environmental and spatial particulars and conditions, where these conditions warrant an increase in the level of detail—same is provided by the computer graphics generation facility. Thus an augmented reality imaging system may provide a low level of augmentation on a clear day, However, when a fog bank tends to obscure a view, the imager can respond to that detected condition and provide increased imagery to improve the portions of the optically captured image which are obscured by fog. Thus, an augmented reality system may be responsive to environmental conditions and states in that they are operable to adjust the level of augmentation to account for specific detected conditions.

These augmented reality imaging systems are not only responsive to environmental conditions but are also responsive to user choices with respect to declared objects of interest or points of interest. Where a user indicates a preferential interested by selecting a specific object, the augmentation provided by a computer graphics generation facility may favor the selected object to the detriment of other objects less preferred. In this way, an augmented reality imaging system of this teaching can permit a user to “see through” solid objects which otherwise tend to interrupt a view of some highly important objects of great interest.

In a third most important regard these augmented reality systems provide computer-generated graphics which have a level of detail which depends on the relative size of a specified object with respect to the imager field-of-view size.

Accordingly, these highly dynamic augmented reality imaging systems are not static like their predecessors, but rather are responsive to detected conditions and selections which influence the manner in which the computer-generated graphics are developed and presented.

### OBJECTIVES OF THE INVENTION

It is a primary object of the invention to provide vision and imaging systems.

It is an object of the invention to provide highly responsive imaging systems which adapt to scenes being imaged and the environments thereabout.

It is a further object to provide imaging systems with automated means by which a computer-generated image portion is applied in response to states of the imaging system and its surrounds.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings, where:

FIG. 1 is an illustration of a user viewing a scene via an augmented reality electronic vision system disclosed herein;

FIG. 2 is an illustrative image of a scene having some basic computer enhancements which depend upon measured conditions of the imaging environments; and

FIG. 3 is a further illustration of the same scene where computer enhancements increase in response to the environmental conditions;

FIG. 4 illustrates an important ‘sec through’ mode whereby computer enhancements are prioritized in view of user selected objects of greatest interest;

FIGS. 5-7 illustrates augmented reality detail being increased in response to the size of an object of interest. in relation to the size of the view field; and

FIGS. 8-11 illustrate some flow diagrams which direct the logic of some portions of these systems.

### PREFERRED EMBODIMENTS OF THE INVENTION

In advanced electronic vision systems, optical images are formed by a lens when light falls incident upon an electronic sensor to from a digital representation of a scene being addressed. Presently, sophisticated cameras use image processing techniques to draw conclusions about the states of a physical scene being imaged, and states of the camera, These states include the physical nature of objects being . . . imaged as well as those which relate to environments in which the objects are found. While it is generally impossible to manipulate the scene being imaged in response to analysis outputs, it is relatively easy to adjust camera subsystems accordingly.

In one illustrative example, a modern digital camera need only analyze an image signal superficially to determine an improper white balance setting due to artificial lighting. In response to detection of this condition, the camera can adjust the sensor white balance response to improve resulting images. Of course, an ‘auto white balance’ feature is found in most digital cameras today, One will appreciate that in most cases it is somewhat more difficult to apply new lighting to illuminate a scene being addressed to achieve an improved white balance.

While modern digital cameras are advanced indeed, they nevertheless do not presently use all of the information available to invoke the highest system response possible. In particular, advanced electronic cameras and vision systems have not heretofore included functionality whereby compound augmented reality type images which comprise image information from a plurality of sources is multiplexed together in a dynamic fashion, compound augmented reality type image is one which is comprised of optically captured image information combined with computer-generated image information. In systems of the art. the contribution from these two image sources is often quite static in nature, An example, a computer-generated wireframes model may be overlaid upon a real scene of a cityscape to form an augmented reality image of particular interest However, wireframe attributes are prescribed and preset via the system designer rather than dynamic or responsive to conditions of the image scene, image environment, or and the points of interest or image scene subject matter. The computer-generated portion of the image maybe the same (particularly with regard to detail level) regardless of the optical signal captured.

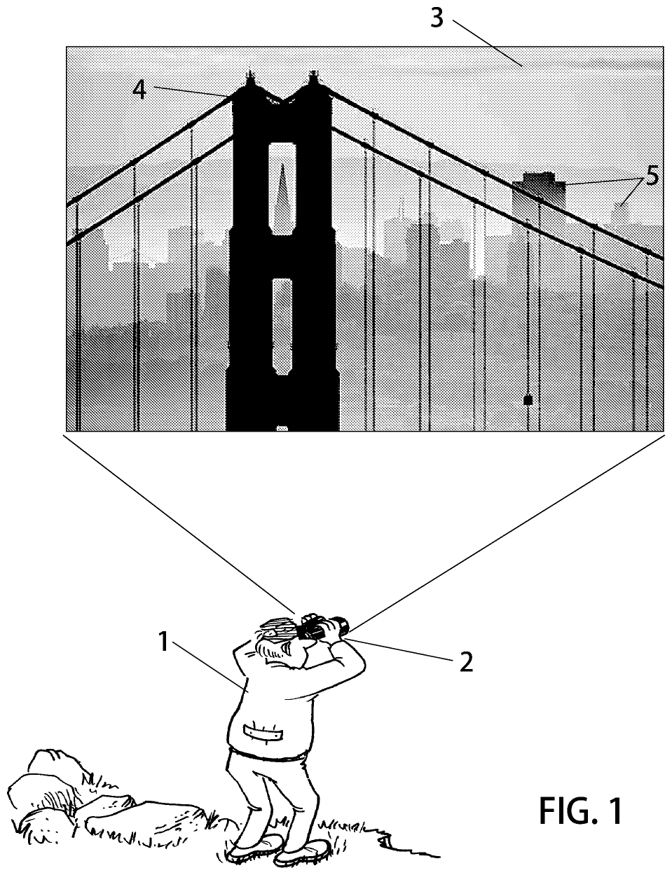

In an illustrative example, a system user 1 addresses a scene of interest—a cityscape view of San Francisco. In this example, the user views the San Francisco cityscape via an electronic vision system 2 characterized as an augmented reality imaging apparatus, Computer-generated graphics are combined with and superimposed onto optically captured images to from compound images, which may be directly view An image 3 of the cityscape includes the Golden Gate Bridge 4 and various buildings 5 in the city skyline. San Francisco is famous for its fog, which comes subsequently to upset the clear view of scenes such as the one illustrated as FIG. 1. While the bridge in the foreground is mostly visible, objects in the distance are blocked by the extensive fog.

Because the presence of fog is detectable, indeed it is detectable via many alternative means, these systems may be provided where dynamic element thereof are adjustable or responsive to values which characterize the presence of fog.

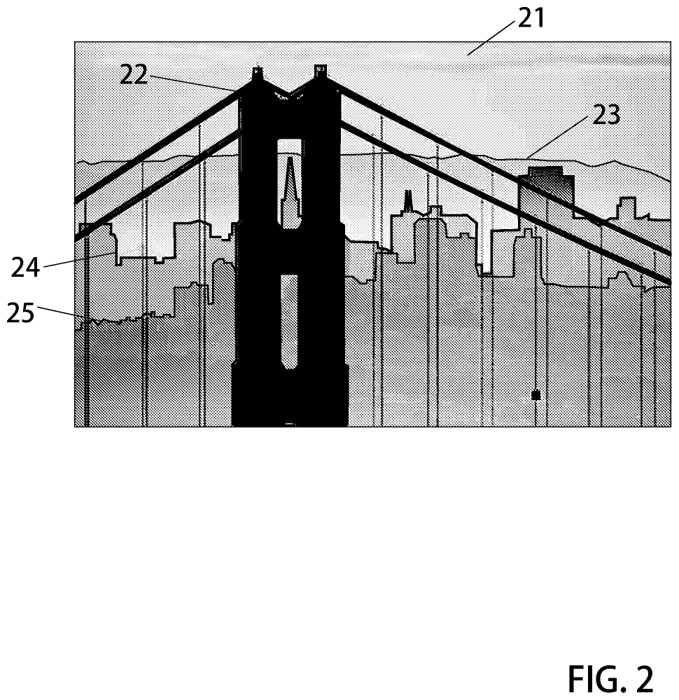

FIG. 2 presents one simple version of an image formed in accordance with the augmented reality concepts where the presence of fog is indicated. The San Francisco skyline image 21 includes a first image component which is optically produced by an imager such as a modern digital CCD camera, and a second image component which is generated by a computer graphics processor_ These two image sources yield information that when combined together with careful alignment from an augmented reality image. The bridge 22 may include enhanced outlines at its edges. Mountains far in the background may be made distinct by a simple line enhancement 23 to demark transition to the sky. Buildings in the background may he made more distinct by edge enhancement lines 24 and similarly buildings in the foreground and also be similarly distinguished 25.

As a result of fog being present as sensed by the imaging system, the computer responds by adding enhancements appropriate for the particular situation. That is, the computer-generated portion of the image is dynamic and responsive to environmental states of the scene being addressed. In best versions, the processes may be automated. The user does not have to adjust the device to encourage it to perform in this fashion, but rather the computer-generated portion of the image is provided by a system which detects conditions of the scene and provides computer-generated imagery in accordance with those sensed or detected states.

To continue the example, as nightfall arrives the optical imager loses nearly all ability to provide for contrast. As such, the computer-generated portion of the image becomes more important than the optical portion, A further increase in detail of the computer-generated portion is called for without user intervention, the device automatically detects the low contrast and responds by turning up the detail of the computer generated portions of the image.

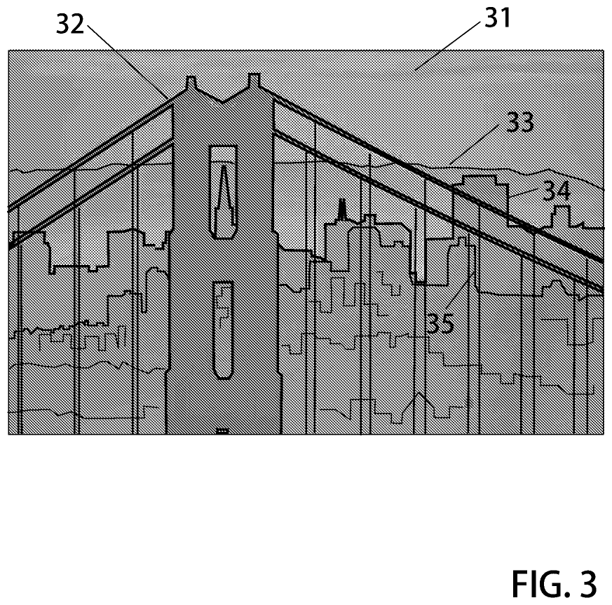

FIG. 3 illustrates additional image detail provided by the computer graphics processor and facilities. Since there is little or no contrast available in the optically generated portion of the image 31 the computer-generated image portion must include further details. A detector coupled to the optical image sensor measures the low contrast of the optically generated image and the computer system responds by adjusting up the detail in the computer-generated imagery. The bridge outline detail 32 may be increased. Similarly outlines for the terrain features 33 and buildings 34 and 35 are all increased in detail. In this way, the viewer readily makes out the scene despite there being little image available optically. It is important to analyze the primary feature being described here. That is, a computer graphics generator which is responsive to conditions of the environment (fog being present) as well as the computer graphics generator being responsive to the optical image sensor (low contrast). These automatic adjustments provide that level of detail of augmented reality images with respect to the computer generated portions thereof correspond to the need for augmentation. An increase in need as implied by conditions and states of scenes being addressed, results in an increase in detail of graphics generation. Starting from an Augmented Reality (AR) default level of detail the detail of computer generated graphics is either increased or decreased in accordance with detected and measured environmental conditions.

while environmental factors are a primary basis upon which these augmented reality systems might be made responsive, there are additional important factors related to scenes being addressed where the manner and performance of computer generated graphics is responsive, Namely, computer graphics generation facility may be made responsive to specified objects such that a greater detail of one object is provided, and sometimes at the expense of detail with respect to a less preferred object.

In a most important version of these electronic vision systems, a user selects a particular point-of-interest (POI) or object of high importance. Once so specified, the graphics generation can respond to the user selection by generating graphics which favor that object m the ‘expense’ of the others. In this way, a user selection influences augmented images and most particularly the computer-generated portion of the compound image such that detail provided is dependent upon selected objects within the scenes being addressed. Thus, depending upon the importance of an object as specified by a user, the computer-generated graphics are responsive.

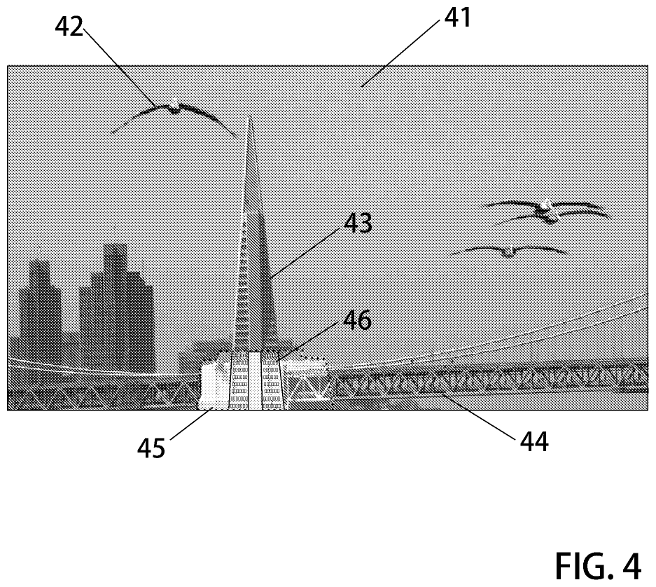

With reference to the drawing FIG. 4, another image scene of a San Francisco cityscape 41 including live/active elements imaged optically in real-time pelicans 42 in flight. The famous Transamerica Tower 43 lies partly hidden and behind a portion of the Bay Bridge 44, Because the electronic vision system is aware of its position and pointing orientation, it ‘knows’ which objects are within the field-of-view. In these advanced systems, a menu control is presented to a user as part of a graphics user interface administration facility, From this interface, a user specifics a preferred interest in the Transamerica Tower over the Bay Bridge, In response to the user selection the computer image generator operates to ‘replace’ the tower in the image portions where the view of the tower would otherwise be blocked by the Bay Bridge. In one implementation of this, an image field region 45 encircled by a dotted line is increased in brightness to make a ‘ghosted’ effect. In the same space, a computer-generated replacement 46 of the Transamerica Tower features (e.g. windows) is inserted. In this way, these electronic vision systems allow a user to view ‘through’ solid objects which are not specified as important in favor of viewing details of those objects: selected as having a high level of importance. An augmented reality system which responds to user selections of objects of greatest interest permits users to see one object which physically lies behind another. While previous augmented reality systems may have shown examples of seeing through’ objects, none of these were based upon user selections of priority objects.

In review, systems have been described which provide a computer generator responsive to environmental features (fog, rain, et cetera); optical sensor states (low contrast); and user preferences with respect to points-of-interest In each of these cases, an augmented reality image is comprised of optically captured image portion and a computer-generated image portion, where the computer generated image portion is provided by a computer responsive to various stimuli such that the detail level of the computer generated images varies in accordance therewith, The computer generated image portion, dependent upon dynamic features of the scene, the scene environments, or user's desires,

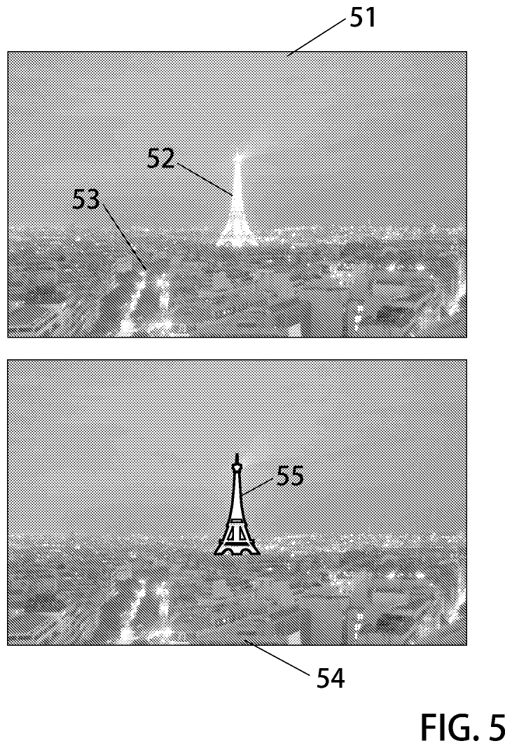

In another important aspect, the computer generated portion of the augmented image is made responsive to the size of a selected object with respect to the image field size, FIG. 5 illustrates. an image 51 (optical image only—not augmented reality) of Paris, France at night. the brightly lit Eiffel Tower 52 and some city streets 53 are visible. The entire Eiffel Tower is about one third (1:3) the height or the image field. As such, the computer-generated portion of the augmented reality image 54 of these systems may include a simple computer-generated representation 55 of the Eiffel Tower. The computer-generated portion of the image may be characterized as having a low level of detail Just a few bold lines superimposed onto the brightly lit portion of the image to represents the tower. This makes the tower very easy to view, as the augmented image is a considerable improvement over the optical only image available via standard video camera systems, Since the augmented portion of the image only occupies a small portion of the image field, it is not necessary for the computer to generate a high level of detail for the graphics which represent the tower.

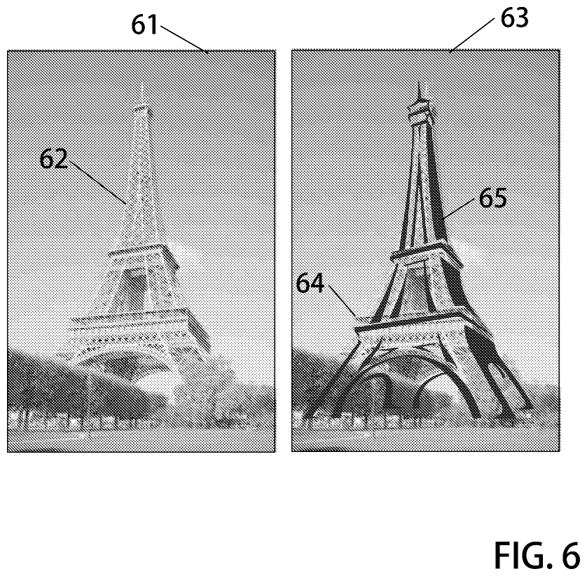

The images of FIG. 6 further illustrate this principle. In a purely optical image, image field 61 contains the Eiffel Tower 62. In an augmented image 63 comprised of both an optically captured image and a computer-generated image portion to form the compound image, the optically captured Eiffel Tower 64 is superimposed with a computer-generated Eiffel Tower 65. Because there is approximately a 1:1 ratio between the size of the object of interest (Eiffel Tower) and the image field, the level of detail in the computer-generated portion of the augmented image is increased. In this particular example presented, detail is embodied as use of curved lines and an increase in the number of elements to represent the tower rather than pure straight wireframe frame image elements of the previously presented figure, For purposes of this example, detail may be expressed in many ways not merely the number of elements but rather the number of elements, shape of those elements, colors, tones. and textures of the elements, among others, Detail in a computer-generated image may come in many forms, it will be understood that complexity or detail of computer-generated portions is increased in response to certain conditions with regard to many of these complexity factors. For simplicity the example is primarily drawn to the number of elements for illustrative purposes.

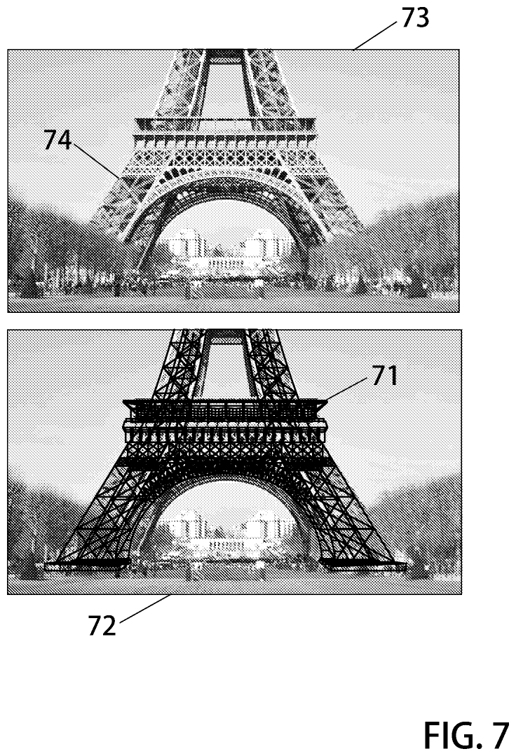

Finally, FIG. 7 illustrates a computer-generated portion 71 of an augmented image 72 whereby the level of detail is significantly increased. A wireframe representation of a lower portion of the Eiffel Tower 74 superimposed upon the optical image 73 of same forms the augmented image. Because the size of the point-of-interest or object of greatest importance (e.g. Eiffel Tower) is large compared to the image field, an increase in detail with respect to the computer generated portion of the augmented image is warranted. The computer-generated portion of the augmented image is therefore made of many elements to show a more detailed representation of the object.

While FIGS. 1-7 nicely show systems which include augmented images having computer-generated portions responsive to conditions of the image scene, these systems also anticipate a manual ‘override’ which permits a user to modify the level of augmentation provided by the computer for each image, a user may indicate a desire for more or less augmentation. This may conveniently be indicated by a physical control like a ‘slider’ or ‘thumbwheel’ tactilely driven control, The slider or thumbwheel control may be presented as part of a graphical user interface or conversely as a physical device operated by forces applied from a user's finger for example.

Once an augmented image is presented to a user, the level of augmentation being automatically decided by the computer in view of the environmental image conditions, object importance, among others, the presented image may be adjusted, with respect to augmentation levels simply by sensing tactile controls which may be operated by the user. In this way, a default level of augmentation may be adjusted ‘up’ or ‘down’ with inputs from its human operator

Distance to a user selected object or point-of-interest may be used to determine whether computer generated graphics related to same selected point-of-interest is available or useful to the user of an augmented reality vision system.

By the term ‘useful’ it is meant that the graphics are of a size which when presented in conjunction with an optical image, those graphics contribute to a better understanding of the image scene. Graphical elements (usually prepared models stored in memory) which are too small in relation to the image being presented or too large are not ‘useful’ for purposes of this meaning. Some computer generated graphical elements are only ‘useful’ in augmented images under certain circumstances. If those circumstances are not met, then these computer generated graphical elements are said to be ‘not useful’, in another example which illustrates ‘useful’ computer generated graphics elements, a computer may include representations of objects where those objects appear under special lighting conditions. For example a stored graphical model of the Golden Gate bridge as it appears lit at night may reside in memory, however that model while available for recall is not ‘useful’ during daylight hours as it cannot be combined with optical images taken during daylight hours to make a sensible compound image. Accordingly, while graphics might be available for recall. their size, texture, simulated lighting, et cetera may render them not usable under prescribed circumstance, This is especially the case when graphics elements when rendered (m an optically captured image would appear to small or too large to make a sensible presentation, Therefore, when a point-of-interest is very far or very near, the system must make a determination whether or not these graphical models would be useful in a compound image to be presented, In many cases, this largely depends upon the distance between the electronic vision system and the object or point-of-interest.

In a database of records having information about objects which might be addressed by these systems, and farther records about various of the stored models which represent those objects, the database additionally includes information relating to the conditions under which those models may be best used. For example, some graphical models are only suitable for use when an imager is a specified distance from the point-of-interest. In this case, a threshold associated with die particular computer rendering or model is set lo define at which distance the imager may be from the object in order for the model to be useful.

Accordingly, many points-of-interest have associated therewith a prescribed distance or “augmented reality threshold which indicates the usefulness of a graphics model with regard to distance between the imager and the object.

Since a vision system of these teachings has the ability to determine its position and also to determine the distance to a point-of-interest. being addressed by the vision system and compare this distance to the prescribed augmented reality threshold associated with that particular point-of-interest of the distance between the vision system and the object-of-interest is less that the point-of-interest's prescribed augmented reality threshold, then the particular computer-generated models relating to that point-of-interest are usefully renderable in compound images.

It should be understood that a point-of-interest may have multiple distance thresholds each relating to various graphical models, where each of these models includes more detail. A factor that may be considered when setting the augmented , . . . J, threshold for each specific point-of-interest is the size of the actual object. Mt. Fuji in Japan is a very large object and thus may have a very large augmented reality threshold, for example a distance of 20 km may be associated with most computer models which could represent ML Fuji. Because Mt. Fuji is a very large physical object, augmented reality graphics used in conjunction with optical images may still. he very useful up to about 20 kilometers. when an augmented reality vision system of these teachings is appreciably further than 20 kilometers, then computer generated graphics which could represent Mount Fuji are no longer useful as the mountain's distance from the imager causes it to appear too small in an image field whereby any computer generated graphics would appear too small for practical use.

Alternatively, a point-of-interest such as Rodin's statue ‘The Thinker’ may have computer graphics models having associated therewith an augmented reality threshold distance of only 100 meters. Viewing ‘The Thinker’ which is a much smaller object from great distances (i.e. those distances greater than I 00 meters) makes the object's appearance in the imager so small that any computer-generated graphics used in conjunction with optically captured images is of little or no use to the user.

The augmented reality threshold distance values recorded in conjunction with various computer models may be modified by other factors such as time of day (e.g. night time), local light levels (dusk, overcast, et cetera and therefore is darker), local, weather (e.g. currently foggy or raining at the determined location), and the magnification state and or field of view size of the camera.

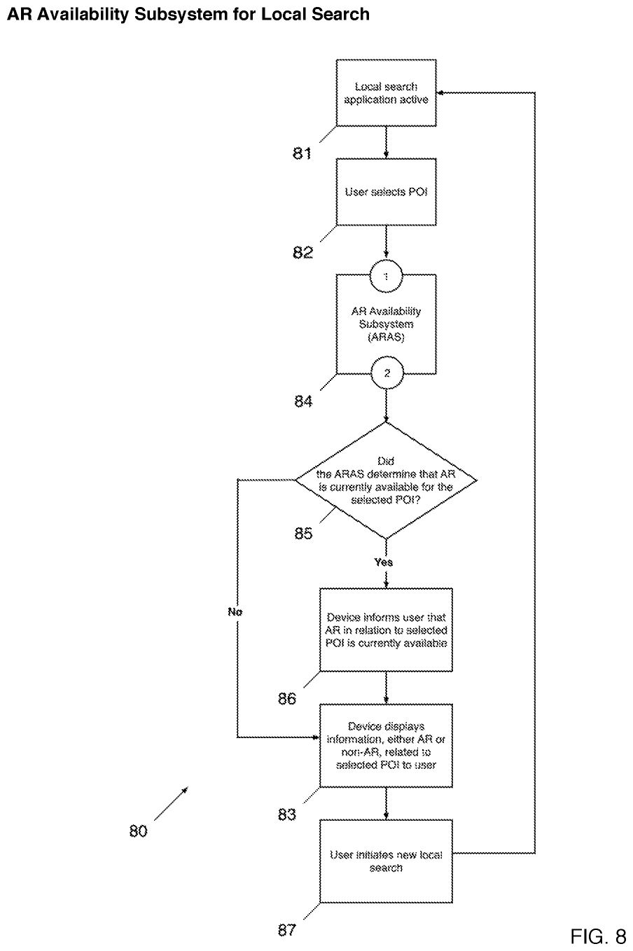

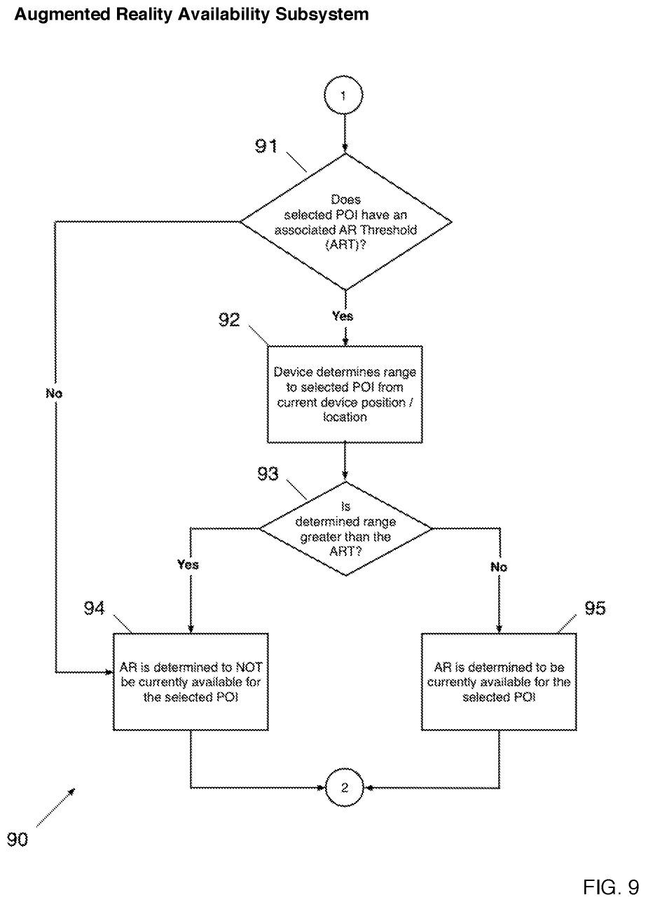

FIGS. 8 and 9 include respectively flowchart 80 and flowchart 90 that illustrate operation of an augmented reality vision system that includes an “Augmented Reality Availability” subsystem. In this description, the computer graphics which make up an ‘augmented reality’ presentation are considered ‘not available’, where those computer generated graphics are determined to be of a nature not useful to the understanding of the image, In many cases,. this is due to the nature of separation between the camera and the object of interest Where the distance is prohibitively large, the rendered graphics, would appear meaningless as they would necessarily be too small. As such, a determination is to be made whether or not any associated computer generated matter is usefully available for a given distance or range, Distance or range may be determined in several ways. In one preferred manner, distance is determined in view of the known latitude and longitude position of objects stored in a database with further reference to GPS positions of a camera on site and in operation.

In step 81 the vision system's local search capability provides users of the systems with points-of-interest known to the system database. Because the GPS informs the computer where the vision system is at any given time, the computer can present a list of objects or landmarks which are represented in the database with computer models that can be expressed graphically. In advanced versions, both position and camera pointing orientation can be considered when providing a list of objects or points-of-interest to an inquiring user.

These points-of-interest which are considered available may be defined as those within a prescribed radius of a certain distance with respect to the location of the vision system, The available points-of-interest may be presented to the user in many forms such as a list, geo-located GUI.

In step 82 a user selects from the presented list a desired point-of-interest. The flowchart then branches to step 91 of the Augmented Reality Availability Subsystem (“ARAS”) 84 and further described in FIG. 9, In step 91 the ARAS determines if the selected point-of-interest has an associated Augmented Reality Threshold (“ART”) distance. If the selected point-of-interest docs have an associated ART distance then the flowchart branches to step 92. If the selected point-of-interest docs not have an associated ART distance, then the flowchart branches to step 94. In step 92 the device determines the distance to the selected point-of-interest by comparing the known location of the point-of-interest to the determined location of the device, in step 93 the system compares a measured distance to the subject point-of-interest, to the ART distance associated with that point-of-interest to determine if the measured distance to the point-of-interest is less than the ART distance. If the actual distance between the vision system and the point-of-interest is less than or equal to the associated ART distance, then the flowchart branches to step 95. If the distance between the vision system and the point-of-interest is greater than the associated ART distance, then the flowchart branches to step 94. In step 94 the ARAS specifics that augmented reality is not currently available for the selected point-of-interest In step 95 the ARAS specifies: that augmented reality is currently available for the selected point-of-interest. The flowchart then branches to step 85. In step 85 the device determines if the ARAS indicated that computer generated graphics is available with respect to the selected point-of-interest If computer generated graphics are determined to be available in relation to the selected point-of-interest, the flowchart branches to step 86. If computer generated graphics are available in relation to the selected point-of-interest the flowchart branches to step 86. If computer generated graphics are determined to be not available in relation to the selected point-of-interest the flowchart branches to step 83. In step 86 the device informs the user that augmented reality graphics are available for the selected point-of-interest. In step 83 the device displays the associated augmented reality and/or non-augmented reality graphics or optically captured imagery associated with the point-of-interest to the user of the device. The non-augmented reality information may be in the form of a list, a geo-located GUI Note that a user of the system may opt lo not view the non-augmented reality information if an augmented reality experience is available, Once the user has viewed the results for a desired length of time the user may initiate a new local search at step 87 and the flowchart branches back to step 81.

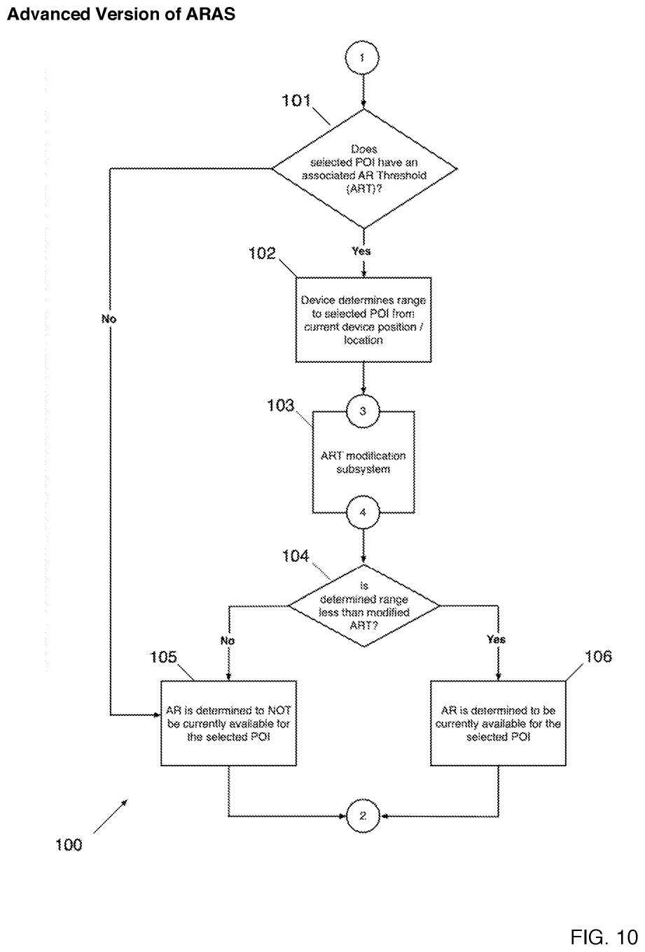

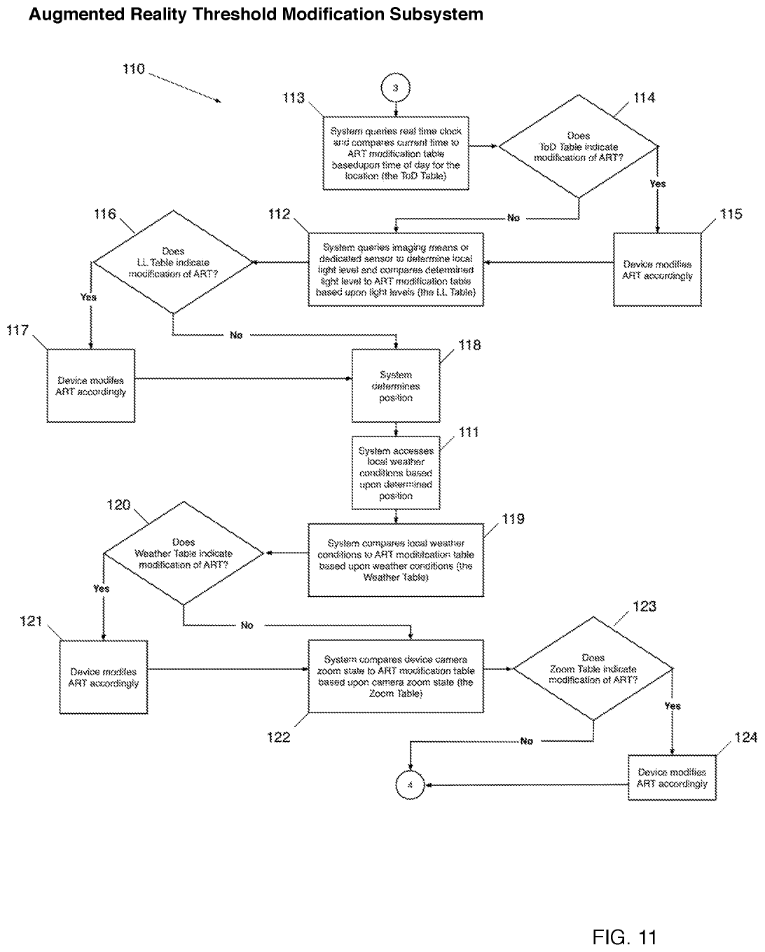

FIGS. 10 and 11 include flowcharts 100 and 110 that illustrate a more advanced version of the Augmented Reality Availability Subsystem (“ARAS”) 84 incorporating an Augmented Reality Range Modification System 103. In step 101 the ARAS determines if the point-of-interest has an associated Augmented Reality Threshold (“ART”). If the selected point-of-interest docs have an associated ART then the flowchart branches to step 102. If the selected point-of-interest docs not have an associated ART then the flowchart branches to step 105. In step 102 the device determines the range to the selected point-of-interest by comparing the known location of the point-of-interest to the determined location of the device. The flowchart then branches to step 113 of the ART Modification Subsystem 103. FIG. 11 is a flowchart 110 that describes one possible embodiment of the ART modification Subsystem making modifications to the augmented reality threshold based upon time of day (steps 113-115), local light level (steps 112, 116 & 117), local weather conditions (steps 118, 117 & 119-121), and the zoom state of the camera of the device (steps 122-124). The flowchart then branches to step 104 and the ARAS determines if augmented reality is available for the selected point-of-interest based upon the determined range and the modified ART in steps 104-106. It should be noted that the ART Modification Subsystem described in FIG. 11 is based on only one possible combination of factors that may be included to modify the ART and is provided to illustrate the point-of-interest nt. The factors described, and other factors such as humidity, vibration and slew rate of the device itself, et cetera, may be used in any combination to modify the ART distance value.

One will now fully appreciate how augmented reality systems responsive to the states of scenes being addressed may be realized and implemented.

Although the present invention has been described in considerable detail with clear and concise language and with reference to certain preferred versions thereof including best anticipated by the inventors, other versions are possible. Therefore, the spirit and scope of the invention should not be limited by the description of the preferred versions contained therein, but rather by the claims appended hereto.

What is claimed is:

1. Imaging systems arranged to form:
compound images from at least two image sources including an optical imager, such as a camera, or other device containing a lens, capable of being used by a user to view a scene;
a computer-based imager comprising of at least one hardware processor, said computer-based imager is capable of determining the external states in the scene and responsive to said external states; and
the computer-based imager further capable of communicating with the optical imager, whereby a portion of compound images provided by the computer-based imager depends upon the external states.
